(19) United States
(12) Patent Application Publication
(10) Pub. No.: US 2010/0134358 A1
(43) Pub. Date: Jun. 3, 2010

(54) Multi-Band Antenna

(75) Inventors: Jia-Hung Su, Taipei Hsien (TW); Yung-Chih Tsai, Taipei Hsien (TW); Kai Shih, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: Cheng Uei Precision Industry Co., Ltd, Taipei Hsien (TW)

(21) Appl. No.: 12/325,658

(22) Filed: Dec. 1, 2008

(51) Int. Cl. H01Q 1/38

(52) U.S. Cl. 343/700 MS

(57) ABSTRACT

A multi-band antenna includes a base plate, a first radiating element, a second radiating element and a third radiating element. The base plate has a first edge, a second edge opposite to the first edge, a third edge and a fourth edge both connecting the first and second edges and opposite to each other. A feeding portion and a ground portion are both extended from the first edge and respectively adjacent to the third edge and the fourth edge, and an opening is formed between the feeding portion and the ground portion. The first radiating element extends from a portion of the second edge adjacent to the third edge and spatially fences the second edge and the fourth edge. The second and third radiating elements tortuously extend from the third edge and are arranged adjacent to each other.

### BACKGROUND OF THE INVENTION

1. Field of the Invention

The present invention relates to a multi-band antenna, and more particularly to a multi-band antenna having reduced size.

2. The Related Art

In recent years, portable wireless communication devices are becoming progressively popular. In order to communicate with other communication devices, various antennas are assembled in these devices for transmitting and receiving electromagnetic waves. Considering the miniaturization trend of the portable wireless communication device, the size of the antenna should be correspondingly reduced in order to be assembled in the limited space of the portable wireless communication device.

Among present wireless technologies, wireless communication bands include global system for mobile communications (GSM) band about 850 MHz, extended global system for mobile communications (EGSM) band about 900 MHz, digital cellular system (DCS) band about 1800 MHz, personal conferencing specification (PCS) band about 1900 MHz and wideband code division multiple access (WCDMA) band about 2000 MHz.

Many different types of antennas for the portable wireless communication devices are used, including planar inverted-F antennas, monopole antennas, loop antennas and the like. However, each of these antennas could not overall meet the demand of operating at multiple frequencies while the sizes thereof are reduced. Therefore, a disadvantage is exposed that the conventional antennas cannot cover multiple frequencies but occupy desirable smaller space concurrently.

### SUMMARY OF THE INVENTION

It is an object of the present invention to provide a multi-band antenna covering multiple bands and having reduced size. The multi-band antenna includes a base plate, a first radiating element, a second radiating element and a third radiating element. The base plate has a first edge, a second edge opposite to the first edge, a third edge and a fourth edge both connecting the first and second edges and opposite to each other. A feeding portion is extended from the first edge and adjacent to the third edge. The feeding portion defines a feeding point thereon. A ground portion is extended from the first edge and adjacent to the fourth edge. The ground portion defines a ground point thereon. And an opening is formed between the feeding portion and the ground portion. The first radiating element extends from a portion of the second edge adjacent to the third edge and spatially fences the second edge and the fourth edge. The second radiating element tortuously extends from the third edge of the base plate. The third radiating element tortuously extends from the third edge of the base plate and is arranged adjacent to the second radiating element.

As described above, the arrangement of the first radiating element, the second radiating element and the third radiating element makes the multi-band antenna transmit and receive multiple bands. The first radiating element spatially fences the second edge and the fourth edge of the base plate, the second radiating element and the third radiating element tortuously extend from the third edge of the base plate, which reduces the size of the multi-band antenna and makes the multi-band antenna take up smaller space when assembled in a portable wireless communication device.

### BRIEF DESCRIPTION OF THE DRAWINGS

The present invention will be apparent to those skilled in the art by reading the following description of an embodiment thereof, with reference to the attached drawings, in which:

FIG. 1 is a plan view of a multi-band antenna in accordance with the present invention;

### DETAILED DESCRIPTION OF THE PREFERRED EMBODIMENT

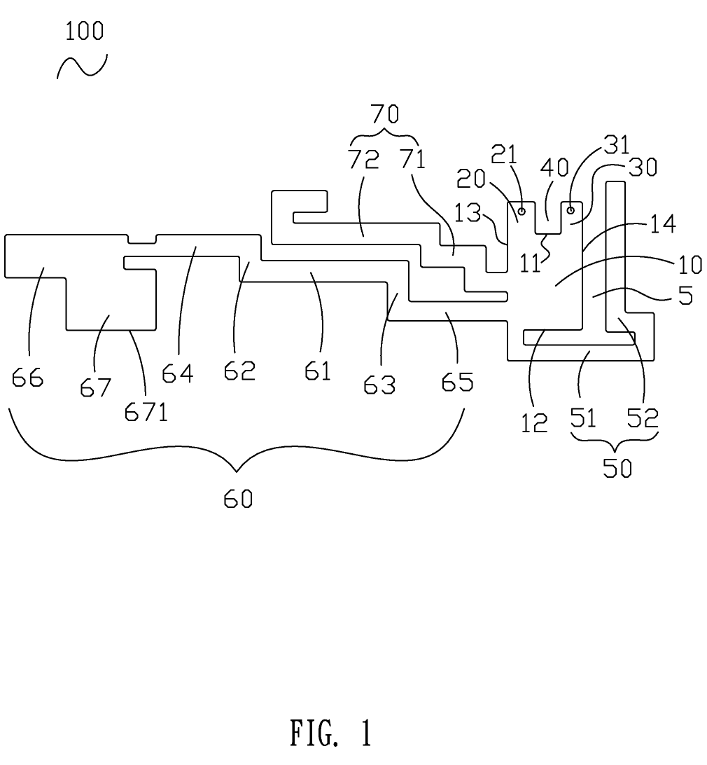

With reference to FIG. 1, a multi-band antenna 100 according to the invention is shown. The multi-band antenna 100 includes a substantially rectangular base plate 10 which defines a first edge 11, a second edge 12 opposite to the first edge 11, a third edge 13 and a fourth edge 14 both connecting the first edge 11 and second edge 12 and opposite to each other.

A feeding portion 20 is extended from the first edge 11 and adjacent to the third edge 13. The feeding portion 20 defines a feeding point 21 thereon. A ground portion 30 is extended from the first edge 11 and adjacent to the fourth edge 14. The ground portion 30 defines a ground point 31 thereon. And an opening 40 is defined between the feeding portion 20 and the ground portion 30 to form a simulation inductance therebetween for tuning bandwidth and input impedance of the multi-band antenna 100 to realize impedance matching between the multi-band antenna 100 and a feeding cable (not shown).

A first radiating element 50 extends from a portion of the second edge 12 adjacent to the third edge 13 and spatially fences the second edge 12 and the fourth edge 14 to define a substantially inverted T-shaped space 5 therebetween. The first radiating element 50 includes a first radiating portion 51 which shows a substantially inverted n-shape connected with the second edge 12 by one free end thereof and a substantially L-shaped second radiating portion 52 connected with the other free end of the first radiating portion 51 by a free end thereof. The L-shaped second radiating portion 52 has long piece (not labeled) spaced from and substantially parallel to the fourth edge 14, and a free end of the long piece is extended beyond the first edge 11.

The multi-band antenna 100 includes a second radiating element 60 tortuously extending from a position of the third edge 13 which is adjacent to the second edge 12. The second radiating element 60 has a base portion 61 horizontally extended. Two opposite ends of the base portion 61 respectively perpendicularly extend in opposite directions to form a first vertical portion 62 and a second vertical portion 63. Free ends of the first vertical portion 62 and the second vertical portion 63 separately extend sideward opposite each other to form a first horizontal portion 64 and a second horizontal portion 65. The second horizontal second 65 is substantially perpendicularly connected with the third edge 13 of the base plate 10. The first horizontal portion 64, the first vertical portion 62, the base portion 61, the second vertical portion 63 and the second horizontal portion 65 form a substantially stairs-shaped structure in combination. A free end of the first horizontal portion 64 continuously extends sideward to form a third horizontal portion 66 wider than the first horizontal portion 64. A substantially rectangular extended portion 67 extends from a side of the third horizontal portion 66 and is partially adjacent to the first horizontal portion 64. The extended portion 67 has an outer edge 671 substantially at the same level with the second edge 12 of the base plate 10.

The multi-band antenna 100 further includes a third radiating element 70 tortuously extending from the third edge 13 of the base plate 10 and adjacent to the second radiating element 60. The third radiating element 70 has a stairs-shaped first extending strip 71 spatially fenced by the second vertical portion 63 and the second horizontal portion 65, and a second extending strip 72 connected with the first extending strip 71 and spatially fenced by the first vertical portion 62 and the base portion 61. The first extending strip 71 extends sideward from the third edge 13 to parallel the second horizontal portion 65 then extends opposite the second horizontal portion 65 to be parallel to the third edge 13, next, extends away from the third edge 13 to parallel the second horizontal portion 65 and then extends opposite the second horizontal portion 65 again to be parallel and adjacent to the second vertical portion 63. The second extending strip 72 extends sideward from a free end of the first extending strip 71 to be parallel and adjacent to the base portion 61 then extends opposite the base portion 61 to parallel the first vertical portion 62 and then extends towards the base plate 10 to be parallel with the base portion 61.

The length of the base plate 10 and the first radiating element 50 substantially equals a quarter of wavelength corresponding to 1940 MHz. The length of the base plate 10 and the second radiating element 60 substantially equals a quarter of wavelength corresponding to 900 MHz. The length of the base plate 10 and the third radiating element 70 is substantially equal to a quarter of wavelength corresponding to 1940 MHz.

When the multi-band antenna 100 is used in wireless communication, an electric current is fed into the multi-band antenna 100 via the feeding point 21. The first radiating element 50 resonates at a higher frequency range covering 1800 MHz to 2000 MHz, and more particularly to resonates at 1900 MHz to 2000 MHz; the second radiating element 60 operates at a lower frequency range covering 850 MHz to 900 MHz; the third radiating element 70 resonates at a higher frequency range covering 1800 MHz to 2000 MHz, and more particularly to resonates at 1800 MHz to 1900 MHz. Therefore, the multi-band antenna 100 obtains frequency range corresponding to GSM band, EGMS band, DCS band, PCS band and WCDMA band in wireless communication.

As described above, the arrangement of the first radiating element 50, the second radiating element 60 and the third radiating element 70 makes the multi-band antenna 100 transmit and receive multiple bands covering 850 MHz, 900 MHz, 1800 MHz, 1900 MHz and 2000 MHz. The first radiating portion 50 spatially fences the second edge 12 and the fourth edge 14 of the base plate 10, the second radiating portion 60 and the third radiating portion 70 tortuously extend from the third edge 13 of the base plate 10, which reduces the size of the multi-band antenna 100 and makes the multi-band antenna 100 take up smaller space when assembled in a portable wireless communication device.

Moreover, the multi-band antenna 100 can be duly bent according to the internal structure of the portable wireless communication device for being conveniently assembled in the portable wireless communication device. Therefore, the multi-band antenna 100 in accordance with the invention not only can transmit and receive multiple bands covering 850 MHz, 900 MHz, 1800 MHz, 1900 MHz and 2000 MHz, but also occupies smaller space in the portable wireless communication device.

What is claimed is:

1. A multi-band antenna, comprising:
a base plate having a first edge, a second edge opposite to the first edge, a third edge and a fourth edge both connecting the first and second edges and opposite to each other;
a first radiating element extending from a portion of the second edge adjacent to the third edge and spatially fencing the second edge and the fourth edge;
a second radiating element tortuously extending from the third edge of the base plate;
a third radiating element tortuously extending from the third edge of the base plate and arranged adjacent to the second radiating portion;
a feeding portion extended from the first edge and adjacent to the third edge, the feeding portion defining a feeding point thereon; and
a ground portion extended from the first edge and adjacent to the fourth edge, the ground portion defining a ground point thereon, an opening being formed between the feeding portion and the ground portion.

2. The multi-band antenna as claimed in claim 1, wherein the first radiating element includes a substantially inverted n-shaped first radiating portion connected with the second edge by one free end thereof and a substantially L-shaped second radiating portion connected with the other free end of the first radiating portion by a free end thereof to be spaced from a long piece which is spaced from and substantially parallel to the fourth edge, therefore a substantially inverted T-shaped space is formed between the second edge, the fourth edge and the first radiating element.

3. The multi-band antenna as claimed in claim 2, wherein the other free end of the L-shaped second radiating portion is extended beyond the first edge.

4. The multi-band antenna as claimed in claim 1, wherein the second radiating element has a base portion horizontally extended, two opposite ends of the base portion respectively perpendicularly extend in opposite directions to form a first vertical portion and a second vertical portion, free ends of the first vertical portion and the second vertical portion respectively extend sideward opposite each other to form a first horizontal portion and a second horizontal portion, the second horizontal portion is substantially perpendicularly connected with the third edge of the base plate, a free end of the first horizontal portion continuously extends sideward to form a third horizontal portion, an extended portion extends from a side of the third horizontal portion and is partially adjacent to the first horizontal portion.

5. The multi-band antenna as claimed in claim 4, wherein the third horizontal portion is wider than the first horizontal portion, the extended portion shows a substantially rectangular shape and has an outer edge substantially at the same level with the second edge of the base plate.

6. The multi-band antenna as claimed in claim 4, wherein the third radiating element has a stairs-shaped first extending strip spatially fenced by the second vertical portion and the second horizontal portion of the second radiating portion, and a second extending strip connected with the first extending strip and spatially fenced by the first vertical portion and the base portion of the second radiating element.

7. The multi-band antenna as claimed in claim 6, wherein the first extending strip extends sideward from the third edge to parallel the second horizontal portion then extends opposite the second horizontal portion to be parallel to the third edge, and extends away from the third edge to parallel the second horizontal portion and then extends opposite the second horizontal portion to be parallel and adjacent to the second vertical portion; the second extending strip extends sideward from a free end of the first extending strip to be parallel and adjacent to the base portion then extends opposite the base portion to parallel the first vertical portion and then extends towards the base plate to be parallel with the base portion.

8. The multi-band antenna as claimed in claim 1, wherein the first radiating element and the third radiating element work at a higher frequency band covering 1800 MHz to 2000 MHz, the second radiating element works at a lower frequency band covering 850 MHz to 900 MHz.
